(19) United States
(12) Patent Application Publication
(10) Pub. No.: US 2004/0041923 A1
(43) Pub. Date: Mar. 4, 2004

(54) Wireless communication apparatus, printing system, and network printing system

(75) Inventor: Takayuki Iida, Kanagawa-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/648,367

(22) Filed: Aug. 27, 2003

(30) Foreign Application Priority Data
Aug. 28, 2002 (JP) 249208/2002

(51) Int. Cl. H04N 5/232

(52) U.S. Cl. 348/231.9

(57) ABSTRACT

Image data obtained by an imaging apparatus such as a digital camera are sent at an advantageous data rate of a wireless LAN communication network. Image data sets obtained by a digital camera and selected for printing are sent to wireless LAN communication equipment via a wireless LAN communication network. The selected image data sets are temporarily stored in a memory of the wireless LAN communication equipment, and sent to an image server via a wired communication line such as an ADSL. Prints are then generated in a mini-laboratory based on the selected image data sets. In this manner, the selected image data sets can be sent to the wireless LAN communication equipment at a data rate of the wireless LAN communication network, without being affected by a data rate of the wired communication line.

### BACKGROUND OF THE INVENTION

1. Field of the Invention

The present invention relates to a wireless LAN communication apparatus for receiving image data sent from an imaging apparatus that obtains the image data by photography and enables transmission of the image data to a wireless LAN communication network. The present invention also relates to a printing system connected to the wireless LAN communication apparatus via a wired communication line, and to a network printing system comprising the wireless LAN communication apparatus and the printing system.

2. Description of the Related Art

Recently, a digital camera having a communication function for sending and receiving image data obtained by photography has been proposed. A user of such a digital camera can send image data obtained by photography to his/her friend by attaching the image data to an E-mail message. Furthermore, the user can send the image data from the digital camera to an image server that stores and manages the image data. Consequently, the user can use a network printing system that stores the image data in the image server. The user can also use the network printing system for viewing images, generating a photograph album, carrying out desired image processing on the image data, and placing a printing order regarding the image data with a laboratory connected to the image server, by accessing the image server from a personal computer or the like.

Meanwhile, wireless LAN communication equipment is being installed in busy places such as a railroad station, a bus stop, a municipal office, a bank, a convenience store, a fast food restaurant, and a downtown area, or in an Internet café. A coverage area surrounding the place in which the wireless LAN communication equipment is installed is called a hot spot. By moving to the coverage area of the hot spot, a user can carry out data communication with the wireless LAN communication equipment or surf the Internet while using a personal computer or the like having a wireless LAN communication function.

A digital camera having a function of communicating with wireless LAN communication equipment has also been proposed. By movement of a user of such a digital camera to a hot spot, image data obtained by the digital camera can be sent via the wireless LAN communication equipment, by being attached to an E-mail message, or to the image server of the network printing system described above.

A data rate of a wireless LAN communication network is substantially high, such as 11 Mbps or more. Therefore, even if the size of data is comparatively large as in the case of image data, the data can be sent in a short time.

Meanwhile, the data are transmitted from the wireless LAN communication equipment to the image server or the like via a wired communication line having a comparatively high speed, such as an ADSL.

An ADSL has a data rate of up to 8 Mbps. However, this rate is for downloading, and a data rate for uploading is up to 1 Mbps. Furthermore, those rates are maximal rates, and the rates can be as low as 100 kbps, depending on a situation such as a distance from a telephone exchange.

The data rate for the image data obtained by the digital camera is the data rate for uploading. Therefore, even if the data rate between the digital camera and the wireless LAN communication equipment is 11 Mbps, the data rate between the image server and the wireless LAN communication equipment is only 1 Mbps at most. For this reason, a user of the digital camera for sending the image data can actually only send the image data at the data rate of the communication line connected to the wireless LAN communication equipment, although the user uses the high-speed infrastructure such as the wireless LAN. As a result, transfer of the image data becomes a time-consuming operation. Especially, in the case where a plurality of digital cameras send image data to the same wireless LAN communication equipment at the same time, the data rate becomes much slower.

### SUMMARY OF THE INVENTION

The present invention has been conceived based on consideration of the above circumstances. An object of the present invention is therefore to enable transfer of image data at a data rate of a wireless LAN communication network, regardless of a data rate of a communication line connected to the wireless LAN communication equipment.

A wireless LAN communication apparatus of the present invention comprises:

wireless LAN communication means for carrying out data communication via a wireless LAN communication network with an imaging apparatus having communication means for sending image data obtained by photography to the wireless LAN communication network; and

temporary storage means for temporarily storing the image data sent from the imaging apparatus; wherein the wireless LAN communication equipment is connected via a wired communication line to a printing system for carrying out printing processing on the image data.

The communication means of the imaging apparatus is used for data communication via the wireless LAN communication network. A data rate thereof is assumed to be 8˜11 Mbps or more and a communication charge therefor is assumed to be fixed.

The wireless LAN communication means supports a standard of IEEE (Institute of Electrical and Electronic Engineers), for example. More specifically, standards such as IEEE 802.11a and IEEE 802.11b are preferably used. The standard IEEE 802.11b is a mainstream standard having a data rate of up to 11 Mbps, and uses a 2.4 GHz spectrum. The standard IEEE 802.11a uses a 5.0 GHz spectrum and has a data rate of up to 54 Mbps. A standard IEEE 802.11g using a 2.4 GHz spectrum and having a data rate of up to 54 Mbps has also been proposed.

The wireless LAN communication apparatus of the present invention is preferably installed in a busy place such as a railroad station, a bus stop, a municipal office, a bank, a convenience store, a fast food restaurant, and a downtown area, or in an Internet café, for example. It is preferable for the wireless LAN communication apparatus to enable communication with the imaging apparatus while the imaging apparatus is moving, by using a roaming function.

WEP (Wired Equivalent Privacy) is preferably adopted for the data communication between the wireless LAN communication apparatus of the present invention and the imaging apparatus. WEP is used for improving security by setting an encryption key to a wireless packet. If WEP is adopted, communication becomes possible only in the case where the WEP set by the communication means of the imaging apparatus agrees with the WEP set by the wireless LAN communication means.

The printing system refers to a system comprising an E-mail server for sending an E-mail message attached with the image data, an image server for storing the image data, and a mini-laboratory connected to the image server and used for generating printed matter from the image data, for example.

The printed matter refers to a print, a photograph album, or a postcard. The printed matter also refers to a T-shirt having an image printed thereon, or a recording medium such as a CD-R recorded with the image data, for example.

A printing system of the present invention comprises:

an image server connected to at least one wireless LAN communication apparatus of the present invention via the wired communication line, for storing the image data sent from the wireless LAN communication apparatus or apparatuses; and

a mini-laboratory for generating printed matter based on the image data stored in the image server.

A network printing system of the present invention comprises at least one wireless LAN communication apparatus of the present invention and at least one printing system of the present invention.

According to the present invention, the image data obtained by the imaging apparatus are sent to the wireless LAN communication apparatus via the wireless LAN communication network, and stored in the temporary storage means of the wireless LAN communication apparatus. Thereafter, the image data are sent to the printing system via the wired communication line. Therefore, the image data sent from the imaging apparatus are not sent immediately to the printing system. Consequently, the data rate of communication between the imaging apparatus and the wireless LAN communication apparatus is not affected by the data rate of the wired communication line. For this reason, the image data can be sent at a high speed and in a short time from the imaging apparatus to the wireless LAN communication apparatus, according to the data rate of the wireless LAN communication network.

### BRIEF DESCRIPTION OF THE DRAWINGS

FIG. 1 is a block diagram showing the configuration of a digital camera used in an embodiment of the present invention;

FIG. 2 is a perspective view of the rear of the digital camera in the embodiment;

FIG. 3 is a block diagram showing a configuration of a network printing system in the embodiment;

FIG. 4 is a flow chart showing procedures carried out at the time of photography with the digital camera;

FIG. 5 is a flow chart showing procedures carried out at the time of transfer of selected image data;

FIG. 6 is a flow chart showing procedures carried out after reception of the selected image data in a broadband town; and

FIG. 7 is a flow chart showing procedures carried out after reception of the selected image data in a broadband satellite.

### DESCRIPTION OF THE PREFERRED EMBODIMENT

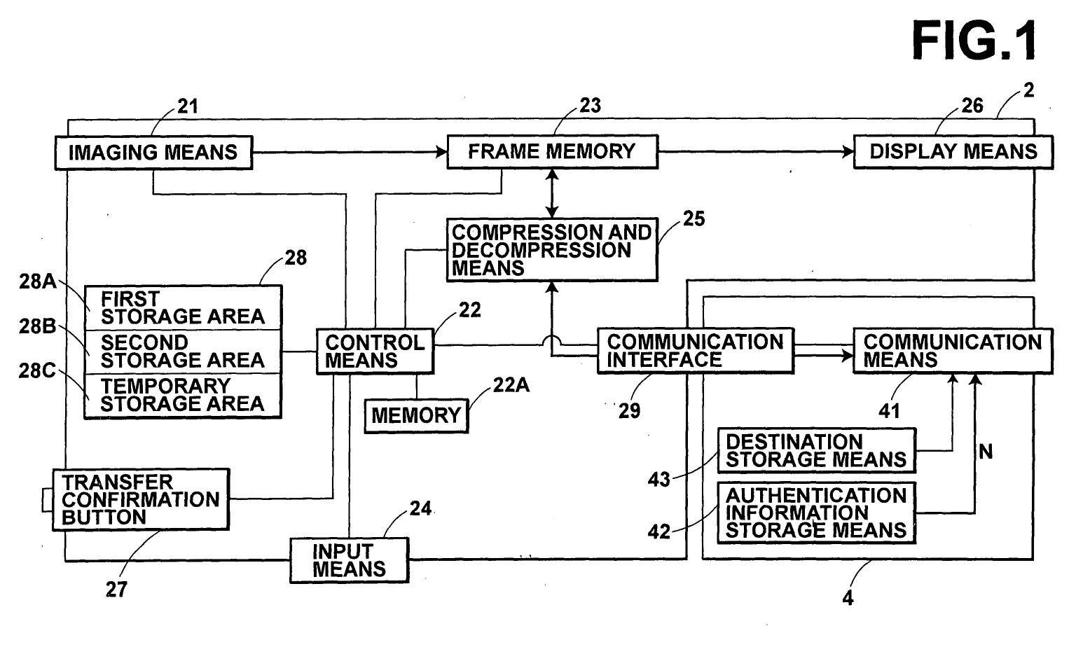

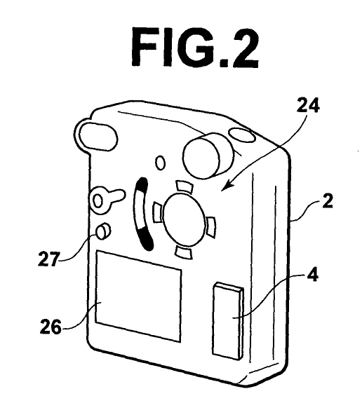

Hereinafter, an embodiment of the present invention will be explained with reference to the accompanying drawings. FIG. 1 is a block diagram showing the configuration of a digital camera used in the embodiment, and FIG. 2 is a perspective view of the rear thereof. As shown in FIGS. 1 and 2, a digital camera 2 comprises imaging means 21, control means 22, a frame memory 23, input means 24, compression and decompression means 25, display means 26, a transfer confirmation button 27, a data memory 28, and a communication interface 29. The imaging means 21 obtains image data sets S0 representing images of subjects by photography thereof. The control means 22 controls the entire digital camera 2. The control means 22 also controls recording, transmission, and display of the image data sets S0, and generates order information C describing the content of an order regarding the image data sets S0. The frame memory 23 stores the image data sets S0 for display thereof. The input means 24 comprises a release button, a communication button, a transmission button, a cruciform key, and number keys for inputting a phone number. The compression and decompression means 25 compresses the image data sets S0 according to a format such as JPEG, and decompresses the compressed image data sets. The display means 26 comprises a liquid crystal display monitor or the like for displaying various kinds of information such as the image data sets S0. The transfer confirmation button 27 is used at the time of photography of each of the image data sets S0, for confirming an intention of transfer thereof to a destination that will be explained later with which a printing order is placed. The data memory 28 stores the image data sets S0 and selected image data sets S1. The communication interface 29 is used for connecting a communication chip 4 for communication with wireless LAN communication equipment, at the time of sending the selected image data sets S1 as will be explained later.

The communication chip 4 comprises communication means 41 for carrying out data communication via a wireless LAN with the wireless LAN communication equipment in a network printing system 1 that will be explained later, authentication information storage means 42 for storing authentication information N that is necessary for communicating with the wireless LAN communication equipment and information on the digital camera 2, and destination storage means 43 for storing the URL of the destination of the selected image data sets S1.

The imaging means 21 comprises a lens, a zoom mechanism, a shutter, and a CCD chip. The imaging means 21 obtains the image data sets S0 representing the images of the subjects by photographing the subjects with use of the shutter.

The control means 22 is connected to a memory 22A comprising a ROM that stores an operation program and a RAM that acts as storage means which is a work area for execution of the program.

A user of the digital camera 2 as a photographer presses the transfer confirmation button 27 during display on the display means 26 of one of the image data sets S0 immediately after photography thereof, in the case where the user wishes to place a printing order regarding the displayed image data set. In this manner, the image data set S0 recorded in the frame memory 23 immediately after photography is stored as one of the selected image data sets S1 in the data memory 28. The printing order refers not only to outputting a print but also recording the selected image data sets S in a recording medium such as a CD-R and storage thereof in an image server of the network printing system.

By pressing the transfer confirmation button 27, the user can set the content of the printing order regarding the selected image data set S1 by using the input means 24. For example, the selected image data set S1 can be printed and stored in the image server of the network printing system or recorded in a recording medium such as a CD-R. In the case of printing, the user inputs a print size, a quantity, and the type of printing (such as postcard generation or album printing) by using the input means 24. After the content of the printing order has been set, the order information C describing the content of the printing order is generated by the control means 22 and, stored in the data memory 28 together with the selected image data set S1. The content of the order can be input in an order content input screen displayed on the display means 26. The order information C may be generated as a file for each of the selected image data sets S1. Alternatively, only one file for the order information C may be generated so that the content of a printing order can be added thereto whenever the selected image data sets S1 are specified.

The data memory 28 comprises a first storage area 28A for storing the selected image data sets S1 and a second storage area 28B for storing the remaining image data sets S0 whose printing is not carried out, and a temporary storage area 28C for storing the image data sets S0 regarding which the user has not decided to place a printing order or to store in the digital camera 2.

The selected image data sets S1 confirmed by pressing the transfer confirmation button 27 are stored in the first storage area 28A, and the image data sets S0 whose storage in the digital camera 2 has been decided are stored in the second storage area 28B. The image data sets S0 whose printing has not been decided by the user are stored in the temporary storage area 28C. The user instructs storage of the image data sets S0 in the second storage area 28B or in the temporary storage area 28C by using the input means 24.

The communication means 41 of the communication chip 4 is used for data communication with the wireless LAN communication equipment in the network printing system via the wireless LAN, and has a data rate of 8˜11 Mbps or more. The communication means 41 supports the IEEE 802.11b standard, as in the case of the wireless LAN communication equipment.

The authentication information storage means 42 stores the authentication information N that is needed by the communication means 41 for communication with the wireless LAN communication equipment, and the information on the digital camera 2.

The authentication information N adopts ESS-ID corresponding to the MAC address of each piece of the wireless LAN communication equipment. ESS-ID is the ID adopted by the international wireless LAN standard IEEE 802.11, and is necessary for establishing a connection to a fixed communication partner. The communication means 41 and the wireless LAN communication equipment have the same ESS-ID. ESS-ID is case sensitive, and comprises 32 1-byte characters or less. The authentication information N also adopts WEP for encryption. The same WEP is used for the wireless LAN communication equipment.

The information on the digital camera 2 refers to a model name thereof. The information may also include a photography condition at the time of photography of the image data sets S0. By sending the information including the model name and the photography condition to the network printing system together with the selected image data sets S1, image processing according to the model of the digital camera 2 and according to the photography condition can be carried out on the selected image data sets S1 in a mini-laboratory or the like installed in a DPE store 14 of the network printing system.

The destination storage means 43 stores the URL of the destination to which the selected image data sets S1 are sent. More specifically, the URL of the DPE store in the network printing system is stored in the destination storage means 43. The URL stored in the destination storage means 43 is referred to when the selected image data sets S1 are sent to the destination.

The URLs of a plurality of destinations may be stored in the destination storage means 43 so that the user can select one of the destinations to which the selected image data sets S1 are sent.

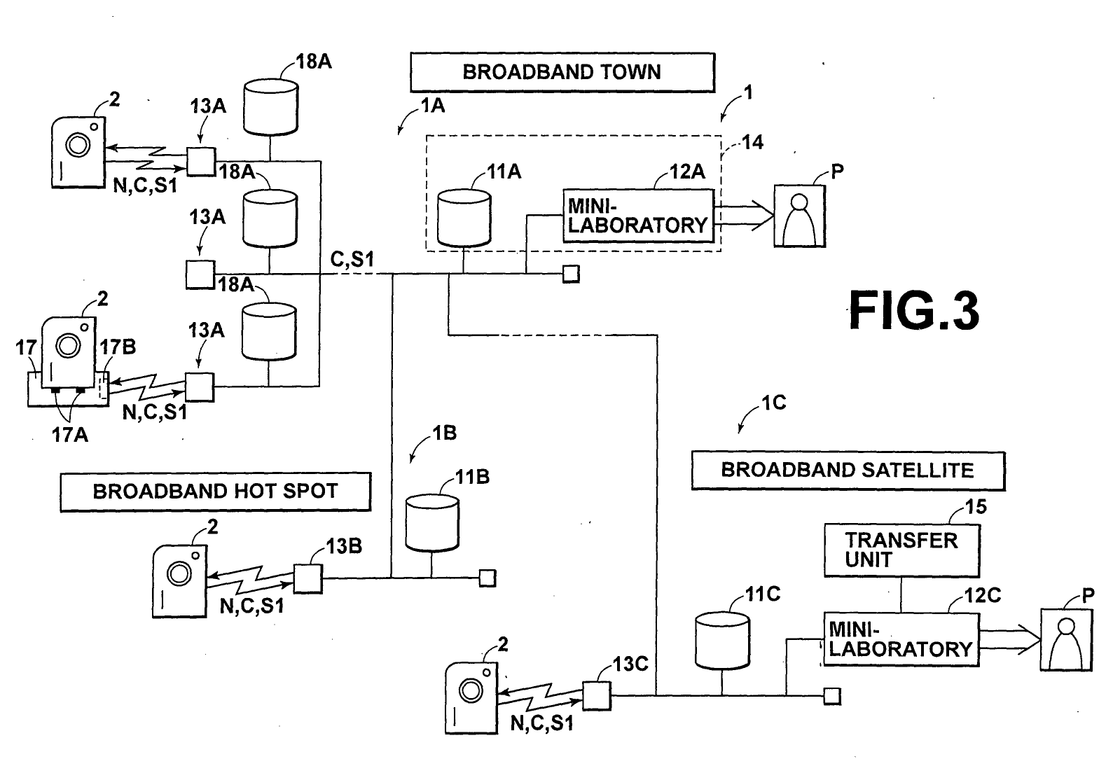

FIG. 3 is a block diagram showing a configuration of the network printing system. The network printing system 1 in FIG. 3 is used for providing printing services regarding the selected image data sets S1 that were obtained by the digital camera 2 and selected for printing.

As shown in FIG. 3, the network printing system 1 comprises a broadband town 1A, a broadband hot spot 1B, and a broadband satellite 1C. The network printing system 1 may comprise a plurality of broadband hot spots 1B and broadband satellites 1C.

The broadband town 1A comprises a large-capacity image server 11A for storing the selected image data sets S1, and a mini-laboratory 12A connected to the image server 11A via a wired LAN for generating prints P based on the selected image data sets S1 and for recording the selected image data sets S1 in a recording medium such as a CD-R. The image server 11A and the mini-laboratory 12A are also connected to a plurality of pieces of wireless LAN communication equipment 13A via a communication line such as an ADSL. The broadband town 1A is installed in an area where the DPE store 14 can provide the printing services.

The image server 11A and the mini-laboratory 12A are installed in the DPE store 14 that runs the network printing system 1.

The mini-laboratory 12A reads the selected image data sets S1 stored in the image server 11A according to the content of the printing order described in the order information C sent from the digital camera 2 as will be explained later, and generates the prints P. The mini-laboratory 12A also records the selected image data sets S1 read from the image server 11A in a recording medium such as a CD-R or a DVD-R. Therefore, the mini-laboratory 12A comprises image processing means for carrying out image processing on the selected image data sets S1, a printer, and a media drive.

The wireless LAN communication equipment 13A is installed at locations within the service provision area of the DPE store 14. For example, the wireless LAN communication equipment 13A is installed in busy places such as a railroad station, a bus stop, a municipal office, a bank, a convenience store, a fast food restaurant, and a downtown area, or in an Internet café. The wireless LAN communication equipment 13A is connected to a memory 18A for temporarily storing the selected image data sets S1 before transmission thereof to the image server 11A.

The wireless LAN communication equipment 13A may comprise Airstation WLA-L11G manufactured by MELCO INC., for example. The wireless LAN communication equipment 13A enables communication.via a wireless LAN communication network, and supports the IEEE 802.11b standard. The wireless LAN communication equipment 13A realizes communication at a data rate of 11 Mbps. Since the wireless LAN communication equipment 13A has been Wi-Fi (the standard for Wireless Fidelity) certified, the wireless LAN communication equipment 13A enables communication with various Wi-Fi certified products. The wireless LAN communication equipment 13A also enables communication via the wireless LAN within a range of 50 m in an office having only a small number of obstacles, a range of 25 m in an office having a large number of obstacles, and a range of 160 m outside, along a line of sight. Furthermore, since the wireless LAN communication equipment 13A can deal with roaming, communication can be carried out even if the user of the digital camera 2 is moving. Moreover, the wireless LAN communication equipment 13A has a multi-channel (14 channels) function for reducing a network load, and a function of MAC address registration and a security function using WEP.

A MAC address is a physical address specific to each piece of network equipment. The first 3 bytes of a MAC address represent a vendor code and is assigned and managed by IEEE. The remaining 3 bytes represent a user code, and is assigned and managed by each manufacturer of the network equipment as numbers specific thereto. No two MAC addresses are the same. A unique physical address is assigned by the 6-byte data. Since each of the MAC addresses is represented by the 6-byte data, up to 1.7 million pieces of network equipment can theoretically be recognized by Wi-Fi.

As an infrastructure of the wireless LAN, Speed Net provided by Tokyo Electric Power Company can be used, for example. Speed Net can provide a service of data transfer at almost the same rate as an ADSL with a fixed charge therefor, by using an optical fiber network and radio antennas installed on utility poles of the company. Speed Net enables wireless LAN communication in a range of 50˜300 m from each of the radio antennas. In this case, by installing each piece of the wireless LAN communication equipment 13A in a place where one of the radio antennas is located, the network printing system 1 can be configured with use of the infrastructure of Speed Net.

A communication service by using a wireless LAN provided by Mobile Internet Services Inc. (MIS) may also be used as the infrastructure for the wireless LAN in this embodiment.

A cradle 17 may also be installed near any one of the pieces of the wireless LAN communication equipment 13A, that is, within the coverage area thereof, for recharging the.digital camera 2 and for sending the selected image data sets S1 to the corresponding piece of wireless LAN communication equipment 13A by reading the data from the digital camera 2. The cradle 17 comprises a terminal 17A for recharging the digital camera 2 and for reading the selected image data sets S1 from the data memory 28, and communication means 17B for communicating with the wireless LAN communication equipment 13A. The communication means 17B has authentication information storage means and destination storage means. The cradle 17 is connected to a 100V power source in order to recharge the digital camera 2.

By using the cradle 17, even if the digital camera 2 does not have the communication chip 4, the selected image data sets S1 can be sent to the wireless LAN communication equipment 13A from the digital camera 2. Especially, in the case where the cradle 17 is located at the home of the user of the digital camera 2, and the home is within the coverage area of any one of the pieces of the wireless LAN communication equipment 13A, the selected image data sets S can be securely sent to the wireless LAN communication equipment 13A during a recharging operation that the user necessarily carries out. Since the recharging operation is necessary, if the selected image data sets S1 are sent during the recharging operation, the user can send the selected image data sets S1 in the recharging operation that he/she necessarily carries out daily, without carrying out a specific operation for sending the selected image data sets S1. Therefore, the user can be less burdened at the time of transfer of the selected image data sets S1.

The broadband hot spot 1B comprises an image server 11B and wireless LAN communication equipment 13B that has the same function as the wireless LAN communication equipment 13A and is connected to the image server 11B via a wired LAN. The capacity of the image server 11B is smaller than that of the image server 11A, and the image server 11B is used for temporarily storing the selected image data sets S1. The broadband hot spot 1B is also connected to the broadband town 1A via a communication line such as an ADSL. The broadband hot spot 1B is installed in a location remote from the service provision area of the DPE store 14 that runs the network printing system 1. For example, if the DPE store 14 is located in Odawara, the remote location refers to a theme park such as Tokyo Disneyland or Universal Studios Japan, a sightseeing spot around Japan, a downtown area in a neighboring city, an airport, a major railroad station around Japan, a fast food restaurant, or a rest area on a highway, for example.

A plurality of pieces of the wireless LAN communication equipment 13B may be used. Furthermore, the cradle 17 may be placed near the wireless LAN communication equipment 13B, as in the case of the broadband town 1A.

The broadband satellite 1C comprises an image server 11C, a mini-laboratory 12C, and wireless LAN communication equipment 13C that are networked via a wired LAN. The capacity of the image server 11C for temporarily storing the selected image data sets S1 is smaller than that of the image server 11A. The mini-laboratory 12C generates the prints P based on the selected image data sets S1. The wireless LAN communication equipment 13C has almost the same function as the wireless LAN communication equipment 13A. The broadband satellite 1C is connected to the broadband town 1A via a communication line such as an ADSL. The broadband satellite 1C is installed in a location away from the area wherein the DPE store 14 that runs the network printing system 1 can provide the services, as in the case of the broadband hot spot 1B.

Since the broadband satellite 1C has the mini-laboratory 12C, the prints P can be generated immediately after reception of the selected image data sets S1 at the remote location. However, the mini-laboratory 12C is smaller than the mini-laboratory 12A installed in the DPE store 14 in the broadband town 1A. Therefore, the mini-laboratory 12C can only generate a print of L size, for example. For this reason, the mini-laboratory 12C has a transfer unit 15, and the transfer unit 15 judges whether or not the printing order described by the order information C can be dealt with by the mini-laboratory 12C. The prints Pare generated in the mini-laboratory 12C only in the case where the printing order can be dealt with by the mini-laboratory 12C. In the case where the mini-laboratory 12C cannot deal with the printing order, the selected image data sets S1 and the order information C received by the broadband satellite 1C are sent from the transfer unit 15 to the DPE store 14 in the broadband town 1A where the prints P are generated.

A plurality of pieces of the wireless LAN communication equipment 13C may also be installed. Furthermore, the cradle 17 may be placed near the wireless LAN communication equipment 13C, as in the case of the broadband town 1A.

When the user of the digital camera 2 moves to the coverage area of the wireless LAN communication equipment 13A, 13B, or 13C (hereinafter referred to as the wireless LAN communication equipment 13A˜13C) and the communication means 41 becomes communicable with the wireless LAN communication equipment 13A˜13C, the control means 22 reads the authentication information N from the authentication information storage means 42, and sends the authentication information N to the wireless LAN communication equipment 13A˜13C via the communication means 41. The wireless LAN communication equipment 13A˜13C judges whether or not the digital camera 2 that sent the authentication information N has been registered with the network printing system 1 run by the DPE store 14. In the case where a result of the judgment is affirmative and the digital camera 2 has been authenticated, the control means 22 sends the selected image data sets S1 stored in the first storage area 28A of the data memory 28 to the wireless LAN communication equipment 13A˜13C, together with the information on the digital camera 2 and the order information C, via the communication means 41.

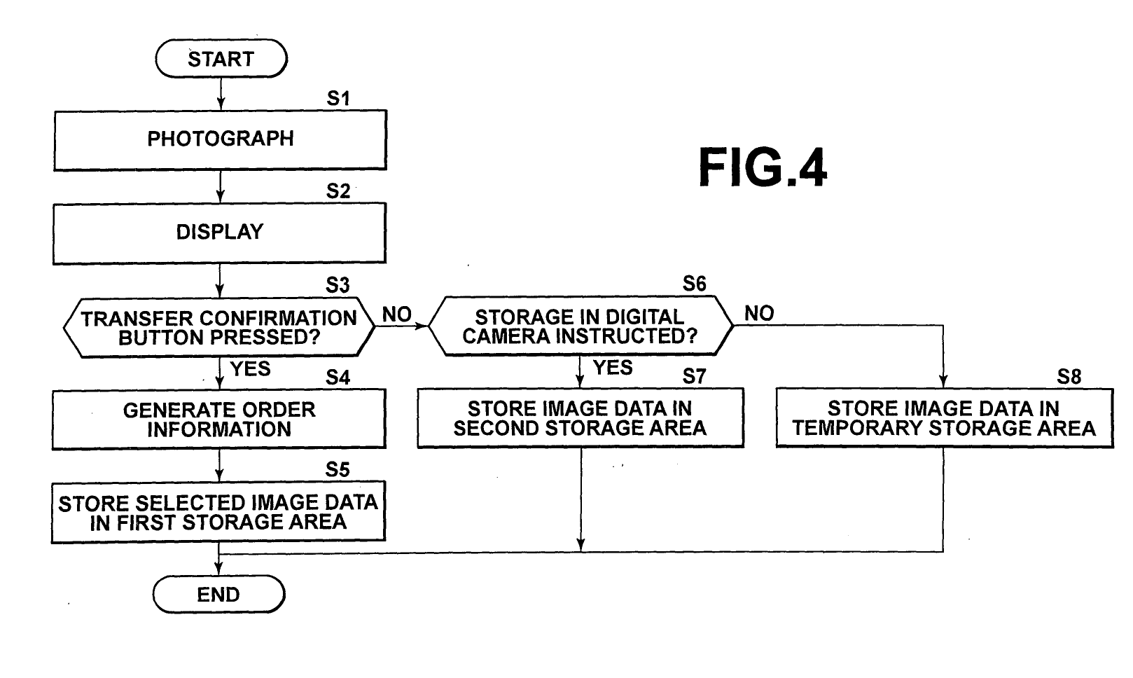

The operation of this embodiment will be explained next. Procedures carried out in the digital camera 2 at the time of photography will be explained first. FIG. 4 is a flow chart showing the procedures. The imaging means 21 photographs one of the subjects, and obtains one of the image data sets S0 that is stored in the frame memory 23 (Step S1). The image data set S0 is displayed on the display means 26 (Step S2).

Whether or not the user has pressed the transfer confirmation button 27 is then judged (Step S3). If a result at Step S3 is affirmative, the image data set S0 becomes the selected image data set S1 to be used for printing, and the order information C is generated based on the order content input by the user from the input means 24 (Step S4). The selected image data set S1 and the order information C are then stored in the first storage area 28A in the data memory 28 (Step S5) to end the process.

If the result at Step S3 is negative, whether the user has input an instruction from the input means 24 is judged for storing the image data set S0 in the digital camera 2 (Step S6). If a result at Step S6 is affirmative, the image data set S0 is stored in the second storage area 28B of the data memory 28 (Step S7) to end the process.

If the result at Step S6 is negative, it is judged that the user has not decided to print the image data set S0 or to store the image data set S0 in the digital camera 2. Therefore, the image data set S0 is stored in the temporary storage area 28C of the data memory 28 (Step S8) to end the process.

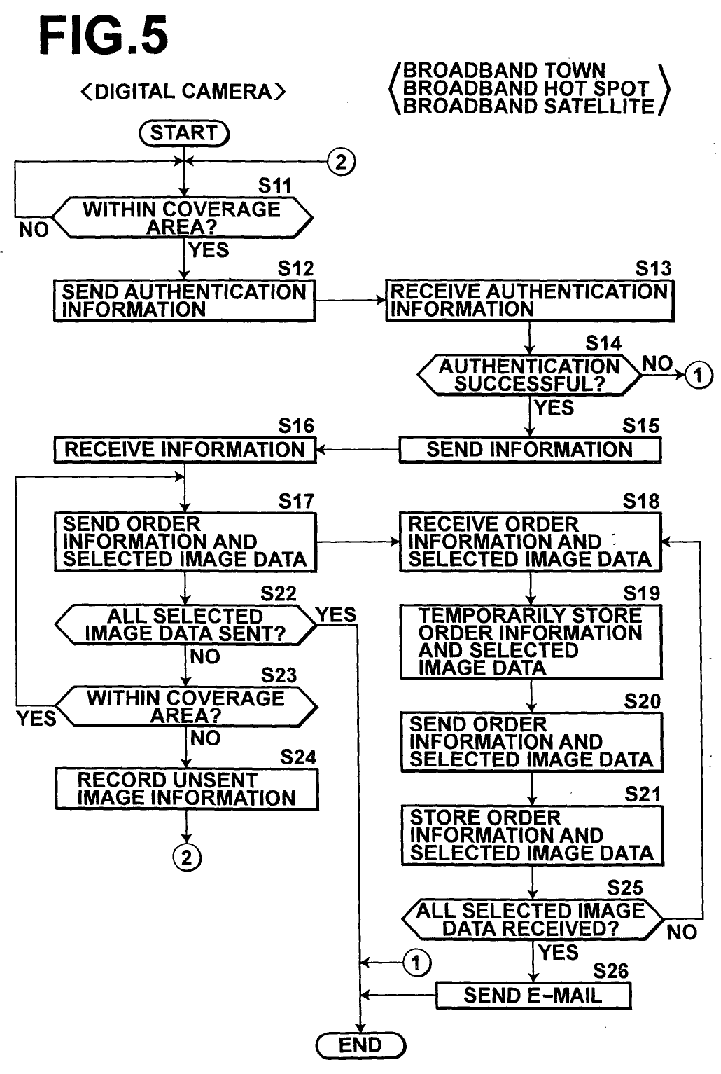

Procedures carried out at the time of sending the selected image data sets S1 from the digital camera 2 will be explained next. FIG. 5 is a flow chart showing the procedures. At the time of transfer of the selected image data sets S1 from the digital camera 2, the same procedures are carried out in the broadband town 1A, the broadband hot spot 1B, or in the broadband satellite C. Therefore, the procedures carried out at the time of sending the selected image data sets S1 from the digital camera 2 to the broadband town 1A will be explained.

In the explanations below, it is assumed that the authentication information N necessary for communication with the wireless LAN communication equipment 13A has been obtained for the digital camera 2 and stored in the authentication information storage means 42. At the same time, it is also assumed that the selected image data sets S1 and the order information C therefor have already been generated and stored in the first storage area 28A in the data memory 28. Therefore, the selected image data sets S1 are ready to be transferred.

In the digital camera 2, the control means 22 is always monitoring whether or not the communication means 41 in the communication chip 4 is within the coverage area of the wireless LAN communication equipment 13A in the broadband town 1A (Step S11). If a result at Step S11 is affirmative, the control means 22 reads the authentication information N stored in the authentication information storage means 42, and sends the authentication information N to the wireless LAN communication equipment 13A from the communication means 41 (Step S12).

In the case where the selected image data sets S1 are sent in a state where the digital camera 2 is set on the cradle 17, the authentication information N stored in the authentication information storage means in the communication means 17B is read and sent to the wireless LAN communication equipment 13A corresponding to the cradle 17 when the user sets the digital camera 2 on the cradle 17.

The authentication information N is received by the wireless LAN communication equipment 13A (Step S13). In the wireless LAN communication equipment 13A, whether or not the digital camera 2 which sent the authentication information N thereto has been registered with the network printing system 1 run by the DPE store 14 is judged, based on the authentication information N (Step S14). If a result at Step S14 is negative and the digital camera 2 was not authenticated, the communication cannot be established, and the process ends. In the case where the digital camera 2 has been authenticated and the result at Step S14 is thus affirmative, information representing the successful authentication is sent to the digital camera 2 (Step S15).

The digital camera 2 receives the information (Step S16). The control means 22 then reads the order information C and the selected image data sets S1 from the first storage area 28A of the data memory 28, and sends the order information C and the selected image data sets S1 to the wireless LAN communication equipment 13A for transfer thereof to the URL of the destination stored in the destination storage means 43 (Step S17). The selected image data sets S1 are sent to the wireless LAN communication equipment 13A in ascending order of photography date, for example.

The wireless LAN communication equipment 13A receives the selected image data sets S1 and the order information C (Step S18), and temporarily stores the selected image data sets S1 and the order information C in the memory 18A (Step S19). The wireless LAN communication equipment 13 A then transfers the selected image data sets S1 and the order information C that were temporarily stored in the memory 18A to the image server 11A according to the URL of the destination (Step S20). The selected image data sets S1 and the order information C are stored in the image server 11A (Step S21).

Meanwhile, in the digital camera 2, whether all the selected image data sets S1 that were stored in the first storage area 28A of the data memory 28 have been sent is judged (Step S22). If a result at Step S22 is affirmative, the process ends. The selected image data sets S1 that have been sent are deleted in order of transmission from the first storage area 28A. If the result at Step S22 is negative, whether or not the communication means 41 is within the coverage area of the wireless LAN communication equipment 13A is judged, in consideration of a possibility of the user being on the move (Step S23). If a result at Step S23 is affirmative, the process returns to Step S17 and transmission of the selected image data sets S1 is continued. If the result at Step S23 is negative, unsent image information is generated representing the fact that some of the selected image data sets S1 have not been sent and still stored in the first storage area 28A, and the unsent image information is stored in the first storage area 28A of the data memory 28 (Step S24). The process then goes back to Step S11. When the unsent image information is generated, the user may be notified of the fact that some of the selected image data sets S1 still remain in the first storage area 28A by a sound such as beeping, for example.

The user of the digital camera 2 can confirm whether or not the unsent image information is stored in the first storage area 28A of the data memory 28. In the case of presence of the unsent image information, the user can understand the fact that not all the selected image data sets S1 have been sent. In this case, the user moves to the coverage area of the wireless LAN communication equipment 13A to send the selected image data sets S1 that have not been sent.

In the wireless LAN communication equipment 13A, whether all the selected image data sets S1 that were stored in the first storage area 28A have been received is judged (Step S25). If a result at Step S25 is affirmative, an E-mail message is sent to the digital camera 2 for notifying completion of the transmission of the selected image data sets S1 (Step S26), to end the process. If the result at Step S25 is negative, the process goes back to Step S18 for continuing reception of the selected image data sets S1.

The user can understand the fact that the selected image data sets S1 have securely been sent to the image server 11A via the broadband town 1A by viewing the E-mail message.

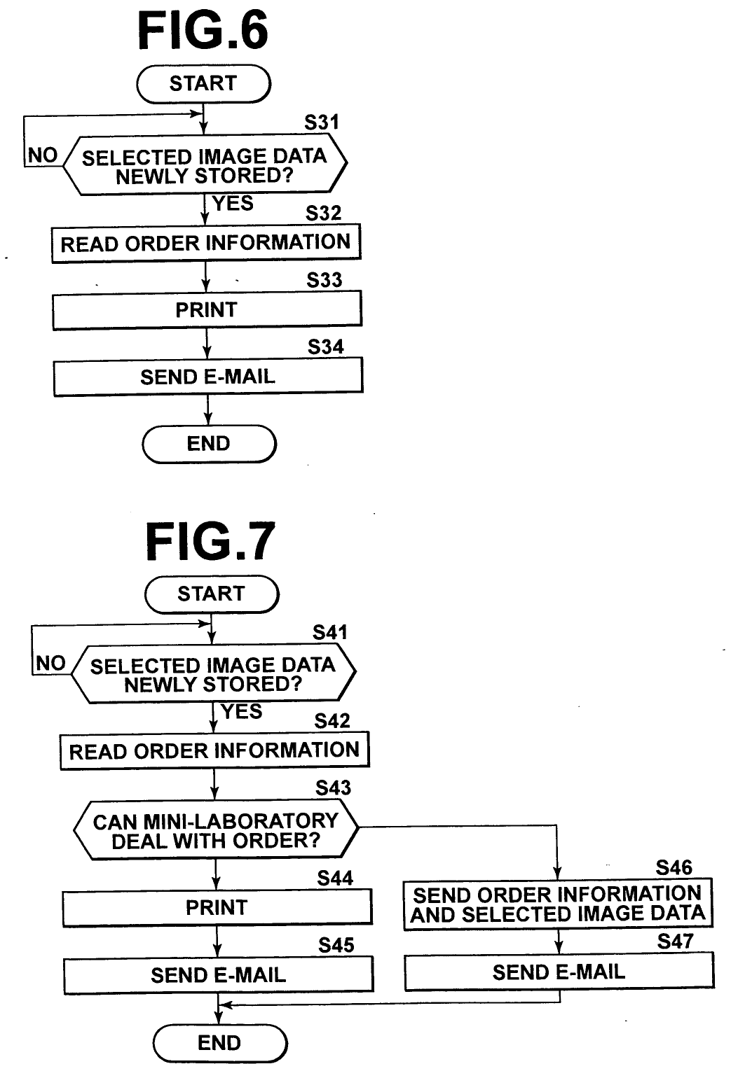

Procedures carried out in the network printing system 1 after reception of the selected image data sets S1 will be explained next. FIG. 6 is a flow chart showing the procedures carried out in the broadband town 1A. In this embodiment, the user of the digital camera 2 is assumed to have described printing of the selected image data sets S1 as the content of the printing order in the order in formation C. In the case where the selected image data sets S1 have been sent to the broadband hot spot 1B, the selected image data sets S1 are temporarily stored in the image server 11B therein, and sent to the image server 11A in the broadband town 1A, based on the URL of the destination.

The image server 11A is regularly accessed by the mini-laboratory 12A, and the mini-laboratory 12A judges whether or not the selected image data sets S1 have been newly stored in the image server 11A (Step S31). In the case where the selected image data sets s1 have been newly stored, a result at Step S31 becomes affirmative, and the mini-laboratory 12A reads the order information C sent together with the selected image data sets S1 (Step S32).

The selected image data sets S1 are read from the image server 11A according to the content of the printing order described in the order information C, and printed after necessary image processing is carried out thereon (Step S33). More specifically, the selected image data sets S are printed according to the size, the quantity, and the type of printing described in the order content. After completion of the printing, an E-mail message and an order reception number issued by the DPE store 14 are sent to the user of the digital camera 2 for notifying the completion of printing (Step S34) to end the process.

The user is informed of the completion of printing of the selected image data sets S1 by viewing the E-mail message, and visits the DPE store 14 for reception of the prints P. At this time, the user is authenticated by the order reception number received together with the E-mail message, and the prints P are provided to the user. In the case where the prints P are to be delivered to a place registered in advance (such as the address of the user) according to an agreement between the DPE store 14 and the user, the prints P are delivered thereto.

A printing charge may be paid directly by the user to the DPE store 14. Alternatively, since the user pays the communication charge to a wireless service provider for communication via the wireless LAN, the user may pay the printing charge to the provider so that the printing charge can be paid to the DPE store 14 via the provider. In this case, since the wireless service provider provides a discount service of its own to the user, the provider can provide a further discount service via the DPE store 14, such as discounting the communication charge in accordance with the use of the DPE store 14.

FIG. 7 is a flow chart showing procedures carried out after the selected image data sets S1 are received by the broadband satellite 1C. The user is again assumed to have described printing of the selected image data sets S1 as the content of the printing order in the order information C.

The case where the user sends the selected image data sets S1 to the broadband satellite 1C refers to the case where the user is in the place where the broadband satellite 1C is located. Therefore, before the user visits the place, the user stores the URL of the image server 11C of the broadband satellite 1C in the destination storage means 43. By selecting the image server 11C in the broadband satellite 1C as the destination of the selected image data sets S1, the selected image data sets S1 are sent to and stored in the image server 11C. The user can select the destination by displaying the destination on the display means 26 and then selecting the destination with use of the input means 24.

The mini-laboratory 12C regularly accesses the image server 11C, and judges whether or not the selected image data sets S1 have been newly stored in the image server 11C (Step S41). In the case where the selected image data sets S1 have been newly stored and a result at Step S41 is thus affirmative, the mini-laboratory 12C reads the order information C received together with the selected image data sets S1 (Step S42).

The transfer unit 15 judges whether or not the content of the printing order described in the order information C can be dealt with by the mini-laboratory 12C (Step S43). If a result at Step S43 is affirmative, the selected image data sets S1 are read from the image server 11C and printed after necessary image processing is carried out thereon, based on the content of the order described in the order information C (Step S44). More specifically, the selected image data sets S1 are printed according to the size, the quantity, and the type of printing described in the content of the order. After completion of the printing, an E-mail message notifying the completion of printing is sent to the user of the digital camera 2 together with a reception number issued by the broadband satellite 1C (Step S45) to end the process.

The user of the digital camera 2 is informed of the completion of printing of the selected image data sets S1 he/she sent, by viewing the E-mail message. The user then visits the broadband satellite 1C to receive the prints P. At this time, the user is authenticated by the reception number sent together with the E-mail message, and the user can receive the prints P. In the case where the prints P are to be delivered to the user according to the agreement between the user and the DPE store 14, the prints P are delivered to the place (the address of the user, for example) that has been registered in advance.

Since the broadband satellite 1C is installed in a theme park or the like where the user visits, the user can obtain the prints P generated from the selected image data sets S1 immediately at the place where the user is visiting.

If the result at Step S43 is negative, the order cannot be dealt with by the mini-laboratory 12C. Therefore, the transfer unit 15 sends the selected image data sets S1 and the order information C to the image server 11A of the DPE store 14 (Step S46). An E-mail message is sent to the user for notifying the user of the fact that the printing is carried out by the DPE store 14 regarding the selected image data sets S1 sent by the user (Step S47), to end the process.

The user knows that the printing is carried out by the DPE store 14 by viewing the message.

As has been described above, according to this embodiment, the image data sets S0 regarding which the user decided to place the printing order are sent as the selected image data sets S1 from the digital camera 2 to the wireless LAN communication equipment 13A˜13C. The selected image data sets S1 are temporarily stored in the memory 18A or the image server 11B, and sent to the image server 11A. Therefore, at the time of sending the selected image data sets S1 from the digital camera 2, the data rate is affected only by a state of the wireless LAN communication network, and not by a data rate of the wired communication line connected to the wireless LAN communication equipment 13A˜13C. Consequently, the selected image data sets S1 can be sent from the digital camera 2 to the wireless LAN communication equipment 13A˜13C at a high speed and in a short time, taking advantage of the data rate of the wireless LAN communication network.

In the above embodiment, the communication chip 4 of the digital camera 2 has the communication means 41, the authentication information storage means 42, and the destination storage means 43. However, only the communication means 41 may be installed in the communication chip 4 while the authentication information storage means 42 and the destination storage means 43 are installed in the digital camera 2.

What is claimed is:

1. A wireless communication apparatus comprising:
wireless communication means for carrying out data communication via a wireless communication network with an imaging apparatus having communication means for sending image data obtained by capturing means to the wireless communication network; and
temporary storage means for temporarily storing the image data sent from the imaging apparatus, wherein
the wireless communication equipment is connected via a wired communication line to a printing system for carrying out printing processing on the image data.

2. The wireless communication apparatus according to claim 1, wherein the printing system comprises:
an image server connected to the wireless communication apparatus via the wired communication line, for storing the image data sent from the wireless communication apparatus; and
a mini-laboratory for generating printed matter based on the image data stored in the image server.

3. The wireless communication apparatus according to claim 1, wherein the printing system is installed in a DPE store.

4. The wireless communication apparatus according to claim 1, wherein the wired communication line is an ADSL.

5. The wireless communication apparatus according to claim 1, wherein the communication means of the imaging apparatus is installed in a communication chip.

6. The wireless communication apparatus according to claim 1, wherein the imaging apparatus sends order information representing the content of a printing order regarding the image data, together with the image data.

7. A printing system comprising:
an image server connected to at least one wireless communication apparatus of claim 1 via the wired communication line, for storing the image data sent from the wireless communication apparatus or apparatuses; and
a mini-laboratory for generating printed matter based on the image data stored in the image server.

8. The printing system according to claim 7, wherein the printing system is installed in a DPE store.

9. The printing system according to claim 7, wherein the wired communication line is an ADSL.

10. A network printing system comprising at least one wireless communication apparatus of claim 1 and at least one printing system of claim 7.
